(19) United States
(12) Patent Application Publication
(10) Pub. No.: US 2010/0114506 A1
(43) Pub. Date: May 6, 2010

(54) METHOD AND APPARATUS FOR DETERMINING CAPILLARY PRESSURES IN A THREE PHASE FLUID RESERVOIR

(76) Inventor: Odd Steve Hustad, Eggkleiva (NO)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/266,307

(22) Filed: Nov. 6, 2008

(51) Int. Cl. G01L 7/00

(52) U.S. Cl. 702/50

(57) ABSTRACT

A method of determining capillary pressures in a fluid reservoir comprising three phases g, o and w, the reservoir being considered as comprising a plurality of gridblocks, and the method comprising, for each gridblock of the reservoir: determining six representative two-phase capillary pressures, the representative capillary pressures being weighted based on saturation, and using the weighted representative capillary pressures to determine at least two of the three capillary pressures g-o, o-w and g-w. The three phases g, o and w may be gas, oil and water respectively. The method may comprise using the weighted representative capillary pressures to determine the gas-oil and oil-water capillary pressures. The method may comprise using the weighted representative capillary pressures to determine two of the capillary pressures, and implying the other capillary pressure from the two capillary pressures determined using the weighted representative capillary pressures. Normalized gridblock saturations may be used. The representative capillary pressures may be weighted as follows:

$$\frac{{S}_{y}}{{S}_{y} + {S}_{z}} {\tilde{P}}_{cxy} ( {S}_{x}^{h} ) ,$$

where x, y and z represent phases g, o and w, in any order, where Sᵢ, i=y, z represents the gridblock saturation of phase i, where Sₓ^{h} represents the hysteresis gridblock saturation of phase x, and where \tilde{P}_{exy}(Sₓ^{h}) is the representative x-y capillary pressure.

### TECHNICAL FIELD

The present invention relates generally to determining saturation profiles of hydrocarbon reservoirs.

More particularly, the present invention relates to a method and apparatus for the determination of capillary pressures in fluid reservoirs having up to three phases, for example, to determine saturation profiles.

### BACKGROUND OF THE INVENTION

Capillary pressure, which generally refers to the difference in pressure across the interface between two immiscible fluids, can be used to determine the nature of subterranean fluid-filled reservoirs. In particular, because different rock types have different capillary properties, saturation profiles and fluid distributions of rock types forming hydrocarbon-containing reservoirs may differ from the profiles and fluid distributions of rock types forming reservoirs containing water, gas, or different concentrations of hydrocarbons. These differences can then be used to identify, locate, and analyze hydrocarbon reservoirs suitable for the extraction of oil. Current methods and apparatus for determining the capillary pressures have a number of drawbacks, however. Therefore, there is generally a need for improvements and modifications to methods and apparatus for modeling capillary pressures to identify, locate, and analyze hydrocarbon reservoirs.

### SUMMARY OF THE INVENTION

According to a first embodiment of the present invention, a method of determining capillary pressures in a fluid reservoir comprising three phases g, o and w, the reservoir being considered as comprising a plurality of gridblocks, comprises receiving input data representing characteristics of the fluid reservoir, and for each gridblock of the reservoir, transforming the input data into six representative two-phase capillary pressures, the representative capillary pressures being weighted based on saturation, transforming the weighted representative capillary pressures into at least two of the three capillary pressures g-o, o-w and g-w, and outputting the at least two capillary pressures as output data.

The three phases g, o and w may be gas, oil and water respectively.

The method may comprise using the weighted representative capillary pressures to determine the gas-oil and oil-water capillary pressures.

The method may comprise using the weighted representative capillary pressures to determine two of the capillary pressures, and implying the other capillary pressure from the two capillary pressures determined using the weighted representative capillary pressures.

Normalized gridblock saturations may be used.

The representative capillary pressures may be weighted as follows:

$$\frac{{S}_{y}}{{S}_{y} + {S}_{z}} {\tilde{P}}_{cxy} ( {S}_{x}^{h} ) ,$$

where x, y and z represent phases g, o and w, in any order, where Sᵢ, i=y, z represents the gridblock saturation of phase i, where Sₓ^{h} represents the hysteresis gridblock saturation of phase x, and where \tilde{P}_{exy}(Sₓ^{h}) is the representative x-y capillary pressure.

The six representative capillary pressures may be: \tilde{P}_{cog}(S_{g}^{h}), \tilde{P}_{cgo}(Sₒ^{h}), \tilde{P}_{cgw}(S_{g}^{h}), \tilde{P}_{cgw}(S_{w}^{h}), \tilde{P}_{cow}(Sₒ^{h}), \tilde{P}_{cow}(S_{w}^{h}), and the representative capillary pressures may be weighted to form three expressions

$$PCG = \frac{{S}_{o}}{{S}_{o} + {S}_{w}} {\tilde{P}}_{cgo} ( {S}_{g}^{h} ) + \frac{{S}_{w}}{{S}_{o} + {S}_{w}} {\tilde{P}}_{cgw} ( {S}_{g}^{h} ) , \\ PCO = \frac{{S}_{g}}{{S}_{g} + {S}_{w}} {\tilde{P}}_{cog} ( {S}_{o}^{h} ) + \frac{{S}_{w}}{{S}_{g} + {S}_{w}} {\tilde{P}}_{cwo} ( {S}_{w}^{h} ) , \\ and$$

$$PCW = \frac{{S}_{g}}{{S}_{g} + {S}_{o}} {\tilde{P}}_{cwg} ( {S}_{w}^{h} ) + \frac{{S}_{o}}{{S}_{g} + {S}_{o}} {\tilde{P}}_{cwo} ( {S}_{w}^{h} ) ,$$

solutions to which three expressions may enable a determination of the at least two capillary pressures, where Sᵢ represents the gridblock saturation of phase i, where Sᵢ^{h} represents the hysteresis gridblock saturation of phase i, and where \tilde{P}_{cij}(Sᵢ^{h}) is the representative i-j capillary pressure.

The method may comprise determining the g-o capillary pressure p_{g}−pₒ based on the expression:

$$\frac{{S}_{g} {\tilde{P}}_{cog} ( {S}_{o}^{h} ) - {S}_{o} {\tilde{P}}_{cgo} ( {S}_{g}^{h} ) + {S}_{w} ( {\tilde{P}}_{cow} ( {S}_{o}^{h} ) - {\tilde{P}}_{cgw} ( {S}_{g}^{h} ) )}{{S}_{g} - {S}_{o} - {S}_{w}} ,$$

where Sᵢ represents the gridblock saturation of phase i, where Sᵢ^{h} represents the hysteresis gridblock saturation of phase i, and where \tilde{P}_{cij}(Sᵢ^{h}) is the representative i-j capillary pressure.

The method may comprise determining the o-w capillary pressure pₒ−p_{w} based on the expression:

$$\begin{matrix}{p}_{o} - {p}_{w} = \frac{( {S}_{g} + {S}_{w} ) PCO - ( {S}_{g} + {S}_{w} ) ( {S}_{g} + {S}_{w} ) PCW}{( {S}_{w} - {S}_{o} - {S}_{g} )} \\ = \frac{{S}_{g} ( {\tilde{P}}_{cgo} ( {S}_{o}^{h} ) - {\tilde{P}}_{cgw} ( {S}_{w}^{h} ) ) - {S}_{w} {\tilde{P}}_{cow} ( {S}_{o}^{h} ) - {S}_{o} {\tilde{P}}_{cow} ( {S}_{w}^{h} )}{( {S}_{w} - {S}_{o} - {S}_{g} )} ,\end{matrix}$$

where Sᵢ represents the gridblock saturation of phase i, where Sᵢ^{h} represents the hysteresis gridblock saturation of phase i, and where \tilde{P}_{cij}(Sᵢ^{h}) is the representative i-j capillary pressure.

The at least two determined capillary pressures may be used in solving a pressure equation in a reservoir simulator, the solving of the pressure equation enabling the determination of a physical property of the reservoir, such as a saturation profile for each of the three phases.

According to a second embodiment of the present invention there is provided a method of simulating a saturation profile for each phase of a fluid reservoir comprising three phases, comprising performing a method according to the first aspect of the present invention to determine the saturation profile for each phase.

The method may comprise controlling an apparatus associated with the reservoir, or any other type of apparatus, in dependence upon a determination made by the method.

According to a third embodiment of the present invention there is provided a program for controlling an apparatus to perform a method according to the first or second aspect of the present invention. The program may be carried on a carrier medium. The carrier medium may be a storage medium. The carrier medium may be a transmission medium.

According to a fourth embodiment of the present invention there is provided an apparatus programmed by a program according to the third aspect of the present invention.

According to a fifth embodiment of the present invention there is provided a storage medium containing a program according to the third aspect of the present invention.

According to a sixth embodiment of the present invention there is provided an apparatus having means for performing the steps according to the first or second aspect of the present invention.

According to another embodiment of the present invention, there is provided a method of determining capillary pressures in a fluid reservoir having three phases g, o and w, the reservoir being considered as comprising a plurality of gridblocks, comprising, for each gridblock of the reservoir, determining six representative two-phase capillary pressures, the representative capillary pressures being weighted based on saturation, and using the weighted representative capillary pressures to determine at least two of the three capillary pressures g-o, o-w and g-w.

According to a further embodiment, a method of determining capillary pressures in a fluid reservoir comprising three phases g, o and w, the reservoir being considered as comprising a plurality of gridblocks, comprises receiving input data representing characteristics of the fluid reservoir, and for each gridblock of the reservoir, transforming the input data into six representative two-phase capillary pressures, transforming the weighted representative capillary pressures into at least two of the three capillary pressures g-o, o-w and g-w, and outputting the at least two capillary pressures as output data. The representative capillary pressures is weighted based on saturation.

According to yet another embodiment, a method of simulating a saturation profile for each phase of a fluid reservoir comprising three phases g, o and w, the reservoir being considered as comprising a plurality of gridblocks, comprises receiving input data representing characteristics of the fluid reservoir, and for each gridblock of the reservoir, transforming the input data into six representative two-phase capillary pressures, transforming the weighted representative capillary pressures into at least two of the three capillary pressures g-o, o-w and g-w, outputting the at least two capillary pressures as output data, and determining the saturation profile for each phase. The representative capillary pressures is weighted based on saturation.

According to additional embodiments, computer-readable media have executable code to cause a machine to perform any of the aforementioned methods.

According to another embodiment, a system for determining capillary pressures in a fluid reservoir comprising three phases g, o and w, the reservoir being considered as comprising a plurality of gridblocks, comprises received input data representing characteristics of the fluid reservoir, and for each gridblock of the reservoir transformed input data, weighted data, and output data. The transformed input data is the received input data transformed into six representative two-phase capillary pressures. The representative capillary pressures are weighted based on saturation. The weighted data are the weighted representative capillary pressures transformed into at least two of the three capillary pressures g-o, o-w and g-w. The output data represent the at least two capillary pressures.

According to another embodiment, a system for simulating a saturation profile for each phase of a fluid reservoir comprising three phases g, o and w, the reservoir being considered as comprising a plurality of gridblocks, comprises received input data representing characteristics of the fluid reservoir, and for each gridblock of the reservoir transformed input data, weighted data, and output data. The system also includes a saturation profile for each phase. The transformed input data is the received input data transformed into six representative two-phase capillary pressures. The representative capillary pressures are weighted based on saturation. The weighted data are the weighted representative capillary pressures transformed into at least two of the three capillary pressures g-o, o-w and g-w. The output data represent the at least two capillary pressures.

Representative capillary pressures can be considered to be values of two-phase capillary pressure made dependent on saturations from three-phase conditions, where the non-applicable third phase is omitted. Two-phase capillary pressure is a unique function of saturation, independent of which of the two saturations chosen. For three phase conditions, the two applicable saturations will result in different values of capillary pressure. The term “representative capillary pressure” derives from Reference 1, described in further detail below. The meaning of this term would be clear to a skilled person upon a reading of Reference 1 together with a reading of this patent application.

The saturation weighting may be an effective weighting. An effective weighting may be considered to be one that is not applied as an explicit step in a method embodying the present invention, but which is effectively present in an expression used in a step of a method embodying the present invention, for example because it has been applied in a derivation leading to the expression concerned. On the other hand, the method may comprise an explicit step to weight the representative capillary pressures.

An embodiment of the present invention applies all six representative capillary pressures, weighting these with saturations depending on the condition at hand. The mathematical derivation leads to explicit expressions for gas-oil and oil-water capillary pressure that may be applied in the pressure equation in reservoir simulators.

An embodiment of the present invention makes use of six representative two-phase capillary pressures to set the gas-oil and oil-water capillary pressure that is used in solving the pressure equation. With an embodiment of the present invention, the third (gas-water) capillary pressure will be more correctly implicitly implied. The mathematical consistency at the two and single phase boundary will more correctly be represented.

An embodiment of the present invention contributes to more consistent representation of the capillary pressures to be used in reservoir simulation for multi-phase flow. Presently, the formulation is developed for fluid systems containing gas, oil and water, but is equally applicable to other three phase systems.

Existing technology for three phase capillary pressure is based on two sets of two-phase capillary pressures (gas-oil and oil-water), where the third two-phase set (gas-water) is implicitly implied. The existing models imply water-wet conditions. The presently existing technology does not appropriately describe the two-phase property of capillary pressure when a third non-mobile phase is present, the third phase being at “residual” saturation.

A particular advantage provided by an embodiment of the present invention is that it does not require the user of reservoir simulator to define the functional dependence of representative capillary pressure on saturation.

According to a third embodiment of the present invention there is provided a program for controlling an apparatus to perform a method according to the first or second aspect of the present invention. The program may be carried on a carrier medium. The carrier medium may be a storage medium. The carrier medium may be a transmission medium.

According to a fourth embodiment of the present invention there is provided an apparatus programmed by a program according to the third aspect of the present invention.

According to a fifth embodiment of the present invention there is provided a storage medium containing a program according to the third aspect of the present invention.

According to a sixth embodiment of the present invention there is provided an apparatus having means for performing the steps according to the first or second aspect of the present invention.

According to a further embodiment of the present invention, there is provided a method of determining capillary pressures in a fluid reservoir comprising three phases g, o and w, the reservoir being considered as comprising a plurality of gridblocks, and the method comprising, for each gridblock of the reservoir: determining six representative two-phase capillary pressures, the representative capillary pressures being weighted based on saturation, and using the weighted representative capillary pressures to determine at least two of the three capillary pressures g-o, o-w and g-w.

### BRIEF SUMMARY OF THE DRAWINGS

Reference will now be made, by way of example, to the accompanying drawings, in which:

FIG. 1 shows a ternary representation of saturation space with two-phase relative permeability;

FIGS. 2a to 2f show reference relative permeability and capillary pressure data used in the ID scenarios (for tabulated data, see Table 1 in Appendix starting on page 38);

FIGS. 3a to 3d show saturation profiles for a 1D example, which represents one result obtained by the previous formulation of Reference 1;

FIGS. 4a to 4d show saturation profiles for a ID model using six saturation weighted representative capillary pressures using a method embodying the present invention;

FIG. 5 shows a ternary diagram illustrating the representative capillary pressure dependence on saturation (Equation 29); and

FIG. 6 is a flowchart illustrating schematically a method and corresponding apparatus according to an embodiment of the present invention.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION

A coupled formulation for three-phase capillary pressure and relative permeability for IMPES (implicit pressure, explicit saturation) compositional reservoir simulation is presented. The formulation incorporates primary and hysteresis saturation functions. Hysteresis and miscibility are applied simultaneously to both capillary pressure and relative permeability. Consistency is ensured for all three two-phase boundary conditions, through the application of two-phase data and normalized saturations as in Reference 1 (a full list of References is provided below, starting on page 36). A three phase capillary pressure formulation that incorporates six representative two-phase capillary pressures is presented with consistent handling at the two phase boundaries.

Simulation examples of Water-Alternating-Gas (WAG) injection are demonstrated for water-wet saturation functions. 1D homogeneous model examples are employed to demonstrate the model features and performance.

The literature contains many models and correlations for modeling three-phase flow (see, for example, References 2 to 5). Common for many of these models is their similarity to the Stone-type structure and the property dependence on saturations, which were originally constructed for water-wet systems. This description focuses on an additional implementation of the fully coupled three-phase model of Reference 1, an alternative model for capillary pressure. The relative permeability formulation allows any three-phase property to be dependent on two two-phase properties. The capillary pressure model is extended, applying all six representative two-phase capillary pressures to set the capillary pressures required to solve the pressure equation (transport equations). This extension makes the capillary pressures dependent on all saturations, contrary to the Stone-type model which is dependent on one saturation only. The extension also eliminates the need for the user to define the functional dependence of capillary pressure on saturation.

A common problem encountered with many of these models is that they may be difficult to apply in simulations where hysteresis is required or if the fluid system becomes miscible. For WAG injection processes, if the capillary pressure is made dependent on only one saturation, as in Stone-type models, this can lead to extremely low saturations, say for oil, in the presence of three phases.

The Norwegian State R&D Program for Improved Oil Recovery and Reservoir Technology (SPOR 1985-1991, Reference 6) conducted experiments of gas injection after water flooding and complementary simulations. The modeling work proved to be a difficult task (see Reference 7). The exercise demonstrated that neither of the two models due to Stone (see References 8 and 9) was able to reproduce the experimental oil recoveries. A corrective parameter was introduced to Stone's first model enabling a match of the oil recovery of the experiment having negligible phase behavior (equilibrium gas injection). Applying the flow parameters to the complementary experiment exhibiting significant vaporization, new difficulties were encountered. It was observed that the wetting water phase was most difficult to model and that the vaporization process impacted the flow behavior of the water phase.

The simulation work revealed some shortcomings of the Stone-type models. For example, these model types do not apply the lower gas saturation range of the gas-oil capillary pressure. That is, the gas-oil capillary pressure must be terminated at a gas saturation of one minus irreducible water saturation minus residual oil saturation to gas at irreducible water saturation. The implication of this is that the maximum gas saturation modeled will be significantly lower than what is measured for the gas-oil capillary pressure. This limitation of the Stone-type models can have significant implication for gas injection projects if the modeling inherits end-point saturations that do not permit large enough gas saturation.

The limitations of the Stone-type models were the motivation for developing the model of Reference 1. The model described below utilizes the complete capillary pressure curves for all three phase pairs. This will permit the gas saturation to achieve higher values as permitted by the data used in the modeling.

A preliminary version of the model which was developed and tested in the RUTH program (see References 10 and 11), showed promising results when trying to model experiments with long drainage periods.

For many Norwegian reservoir models, simulating with flow parameters having hysteresis has also shown to be CPU intensive. The presented model has proven to be more efficient compared to an earlier model, including the ability to model miscibility, see Reference 12.

Models are usually developed to address specific reservoir needs for the modeling of recovery processes, such as gas injection after water flooding, WAG injection, or pressure blow-down after water flooding. These models may be generalized to be applicable to other processes and reservoirs. When considering three-phase flow, models have usually been developed for relative permeability to oil, often assumed to be the intermediate wetting phase. This model does not have such restrictions, but linear dependency of the three-phase property on the two-phase property is maintained (Reference 13). Wettability property is assumed incorporated in the two-phase data.

According to an embodiment of the present invention, there is provided a model with formulation modifications and the addition of primary data to hysteresis data. According to another embodiment, there are the two-phase model, how input and gridblock values are related by the two-phase data, the relationship between the primary and hysteresis data, the hysteresis formulation for capillary pressure and relative permeability, and the miscibility formulation. According to a further embodiment, a three-phase model is presented, demonstrating how representative two-phase properties are applied to three-phase properties. According to yet another embodiment, WAG injection simulation examples are demonstrated for a selected ID homogeneous model. Various embodiments of the present invention may fit within the framework of the models presented.

### Two-Phase Formulation

The formulation is constructed in a manner to ensure consistency of three-phase properties at all two-phase boundaries. To achieve this, process dependence normalized saturations are applied. The normalized saturations on both input and gridblock values allow for a one-to-one relationship between these values.

Two-phase data are entered via tables to allow flexibility for the user. The two-phase capillary pressure and relative permeability are entered as functions of one of two saturations. The properties are made dependent on interfacial tension (IFT) or capillary number ratios, relating the entered values to a reference or threshold value.

The hysteresis formulation is based on two limiting scanning curves for increasing and decreasing saturations. The capillary pressure is made continuous for processes having a change in saturation direction through a resealing of the saturation range. For a particular process saturation direction change, the saturations are re-normalized based on the process-dependent end-point and turning-point saturations. The relative permeabilities are also made continuous by applying the same normalized saturations as for the capillary pressure.

Input. The gas-oil, gas-water and oil-water two-phase data are entered into the simulator as function of one of the phase pair's saturation. The data entered refer to a reference interfacial tension. The entered gas-oil data differ from the traditional data used in the Stone-type models in that the gas-oil data are at zero water saturation. The oil-water data may be applied to the gas-water data. This is recommended for miscible runs in that the water-hydrocarbon properties must be unique values of water saturation when the hydrocarbon phase label changes at miscibility. This is especially important when using tabulated values.

Several saturation function sets may be entered depending on the variability in properties required to model the dynamic reservoir behavior. These different sets of saturation functions are assigned to gridblocks (or volume elements) on an appropriate regional basis. Each two-phase data set consists of three process direction curves. For example, the oil-water input data may be represented by a primary decreasing water saturation curves, a secondary increasing water saturation curves and a tertiary decreasing water saturation curves. The use of three sets of curves per saturation function set, instead of the two sets more conventionally associated with hysteresis modeling, introduces additional complexity in terms of both data entry and data management during the simulation process.

During the calculation procedure the input saturations are normalized with respect to their end-point saturations by

$${S}_{i} = \frac{{\breve{S}}_{i} - {\breve{S}}_{irj}}{1 - {\breve{S}}_{irj} - {\breve{S}}_{jri}} , i , j = g , o , w \qquad ( 1 )$$

before relating the input values to the gridblock values. That is, the input properties are made functions of normalized saturations such that all saturation function table look-up is performed in normalized space of zero to one. The reader may refer to the nomenclature for a more comprehensive variable description.

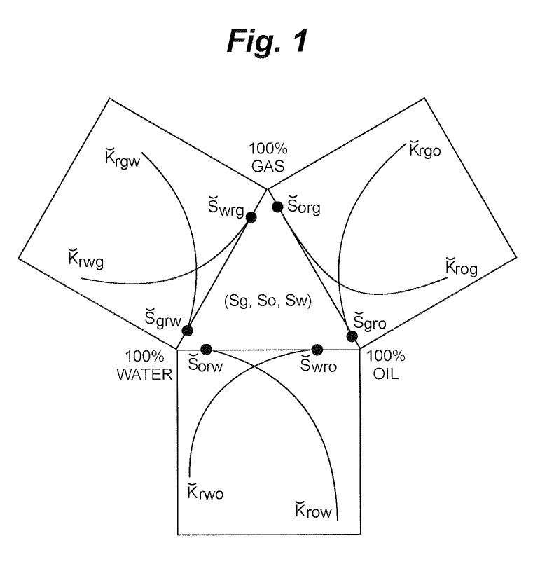

A ternary illustration of the saturation space with one set (secondary or tertiary) of the two-phase relative permeabilities and end-point saturations is shown in FIG. 1. Included in the figure are three two-phase relative permeability sets and six end-point saturations.

Gridblock. Each gridblock is assigned six primary reference end-point saturations and six hysteresis end-point saturations, which in principal should comply with the reference IFT in the input table data. The end-point saturations are denoted by

S̅_{gro}^{pr}, S̅_{grw}^{pr}, S̅_{org}^{pr}, S̅_{orw}^{pr}, S̅_{wrg}^{pr} and S̅_{wro}^{pr} (2)

S̅_{gro}^{hr}, S̅_{grw}^{hr}, S̅_{org}^{hr}, S̅_{orw}^{hr}, S̅_{wrg}^{hr} and S̅_{wro}^{hr} (3)

The primary process (curves) always starts at 100% water saturation and/or zero gas saturation. This implies, to ensure consistency, that the primary and hysteresis end-point saturations S_{org}, S_{wrg} and S_{wro} must be equal.

For processes exhibiting two-phase flow, the simulation gridblock saturations are normalized as in Equation 1, where the end-point saturations and saturations are those pertaining to the gridblock.

The gridblock reference end-point saturation may also be made dependent on either interfacial tension (IFT) or capillary number (N_{c}). This invokes a scaling on the end-point saturations as the flow conditions change.

The same end-point saturation scaling is also applied to the relative permeability described below. The scaling requires specification of threshold values which indicate whether scaling should be applied. Above the threshold value the property remains unaltered whereas below the threshold value the scaling should be applied and the process is assumed to approach miscible conditions. The scaling function for IFT is

$${f}_{ij}^{IFT} = {( \frac{{σ}_{ij}}{{σ}_{ij}^{th}} )}^{{n}_{ij}} , \qquad ( 4 )$$

and for capillary number it is

$${f}_{ij}^{{N}_{c}} = {( \frac{{N}_{cij}^{th}}{{N}_{cij}} )}^{{m}_{ij}} , \qquad ( 5 )$$

where σᵢⱼ^{th} and N_{cij}^{th} are the threshold IFT and capillary number respectively, and nᵢⱼ and mᵢⱼ are user defined constants. The end-point saturations may then be scaled as

S̅ᵢᵣⱼ^{m}= S̅ᵢᵣⱼ^{κ}·fᵢⱼ^{η} (6)

where κ refers to pr or hr, and η refers to IFT or N_{C}. Note, for the IFT scaling to occur, the IFT value must be below a threshold value set by the user. Similarly, for the capillary number scaling, the capillary number must be greater than the threshold value.

The capillary number is defined as

$${N}_{cij} = \frac{{u}_{i} {μ}_{i}}{{σ}_{ij}} \qquad ( 7 )$$

and there are six threshold capillary number values, whereas there are only three IFT threshold values.

The gridblock end-point saturations may also be process dependent. This is most relevant for the primary end-point saturations that differ from the hysteresis end-point saturations. However, the process dependent end-point saturation scaling may be applied to any or all end-point saturations. The process dependent scaling is modeled by

$${\overline{S}}_{irj} = \frac{{\overline{S}}_{i}^{max}}{1 + \frac{{\overline{S}}_{i}^{max}}{{\overline{S}}_{irj}^{m}} - \frac{{\overline{S}}_{i}^{max}}{1 - {\overline{S}}_{jri}^{m}}} , \qquad ( 8 )$$

where i≠j, S̅ᵢ^{max} is the maximum i-phase saturation experienced by the gridblock, and

S̅ᵢ^{max}≦1− S̅ⱼᵣᵢ^{m}. (9)

Switching between primary curves and hysteresis curves requires special treatment of the end-point saturations to ensure smoothness in the normalized saturations during switching. The criteria for switching from primary to hysteresis curves are:

i. Saturation direction change has occurred

ii. The relative permeabilities are within the bounds of the hysteresis curves

iii. The saturations are within the bounds of the hysteresis end-point saturations

Once the switching criteria are fulfilled and the saturation has changed direction the end-point saturations will start migrating from their lower primary curve end-point values to the greater hysteresis end-point values by the saturation change of the process. That is

S̅ᵢᵣⱼ= S̅ᵢᵣⱼ^{p}+Sᵢ^{3h}, S̅ᵢᵣⱼ< S̅ᵢᵣⱼ^{h}. (10)

The Sᵢ^{3h} is the normalized saturation determined by applying the hysteresis end-point saturations only.

Hysteresis. The hysteresis formulation requires two sets of two-phase saturation functions, one for increasing and another for decreasing saturations. The increasing and decreasing saturations represent the process direction as pertaining to the three-phase saturation space. The three-phase process direction mirrors onto the two-phase saturation space. Consider the oil saturation's process direction in the three-phase saturation space that is increasing. The two-phase mirror process for the oil-water system may be increasing oil saturation, assuming the oil-water properties are function of water saturation. However, the two-phase mirror process for the gas-oil system may be either increasing or decreasing oil saturation, dependent on whether the gas-oil properties are function of oil or gas saturation, respectively.

The hysteresis formulation requires tracking of the two saturation values to ensure continuity in capillary pressure and relative permeability when switching between the hysteresis curves, see Reference 1. When the process direction changes from say a decreasing to an increasing saturation, the turning-point saturation, Sᵢ^{t}, and the equivalent saturation, Sᵢ^{e} must be determined. The turning-point saturation represents the saturation at which the process direction changes on the mirrored two-phase system. The equivalent saturation represents the saturation value for which the capillary pressure on the increasing curve equals that on the decreasing curve on the mirrored two-phase system.

Once these two saturation values have been determined the normalized hysteresis saturation is determined for the continued process with increasing saturations. The turning-point and equivalent saturations are applied as constants in the hysteresis normalized increasing saturations:

$${S}_{i}^{h} = {S}_{i}^{e} + ( {S}_{i} - {S}_{i}^{l} ) ( \frac{1 - {S}_{i}^{e}}{1 - {S}_{i}^{t}} ) , {S}_{i} \geq {S}_{i}^{l} \qquad ( 11 )$$

where i=g,o,w.

This normalized hysteresis saturation scaling has the effect of compressing the saturation range for the capillary pressure curve (increasing saturation, from the equivalent saturation to one) into the saturation range from the turning-point saturation to one. Both the turning-point and equivalent saturations are normalized values and they are kept fixed as long as the process direction continues in the same direction (increasing saturation).

The turning-point and equivalent saturations are re-calculated when the process direction change to decreasing saturation. For decreasing saturations, the normalized hysteresis saturation takes the form

$${S}_{i}^{h} = {S}_{i} ( \frac{{S}_{i}^{e}}{{S}_{i}^{l}} ) , {S}_{i} \leq {S}_{i}^{l} , i = g , o , w . \qquad ( 12 )$$

The normalized hysteresis saturation, Sᵢ^{h}, is then used to look up the two-phase capillary pressure input value and allocate it to the gridblock.

The relative permeability to phases i and j for a process with increasing saturation is altered slightly from Reference 1 in that the hysteresis loops are closed at the end-point saturations. The previous formulation may result in relative permeability values outside the range of the two scanning curves if the process changes direction often near the end-point saturation with highest relative permeabilities. The relative permeability to phase i for increasing saturation is

$${\tilde{k}}_{rij} ( {S}_{i} ) = {k}_{rij}^{d} ( {S}_{i}^{l} ) + [ {k}_{rij}^{l} ( 1 ) - {k}_{rij}^{d} ( {S}_{i}^{l} ) ] [ \frac{{k}_{rij}^{l} ( {S}_{i}^{h} ) - {k}_{rij}^{l} ( {S}_{i}^{e} )}{{k}_{rij}^{l} ( 1 ) - {k}_{rij}^{l} ( {S}_{i}^{e} )} ] \qquad ( 13 )$$

And phase j

$${\tilde{k}}_{rij} ( {S}_{i} ) = {k}_{rij}^{l} ( {S}_{i}^{h} ) [ \frac{{k}_{rij}^{d} ( {S}_{i}^{l} )}{{k}_{rij}^{i} ( {S}_{i}^{e} )} ] . \qquad ( 14 )$$

kᵣᵢⱼ^{d} and kᵣᵢⱼ^{t} represent the input relative permeability for decreasing and increasing saturations respectively. The hysteresis saturation, Sᵢ^{h}, will start at the equivalent saturation, Sᵢ^{e}, and increase to one. The logic behind Equation 13 is that the first term on the right hand side is the relative permeability value at the saturation where the process direction changes. The second term, first bracket, represents the increase the relative permeability may have to reach the maximum relative permeability on the increasing hysteresis curve. The second term, second bracket, is a term that varies from zero to one. The increasing relative permeability values are chosen for this term to incorporate the shape of the increasing relative permeability curve. It should be pointed out, that for hysteresis capillary curves that have a wide span between them; the increasing relative permeability may be fairly “flat” for saturation values near the turning point saturation.

For a process with decreasing saturation, the relative permeabilities are

$$\begin{matrix}{\tilde{k}}_{rij} ( {S}_{i} ) = {k}_{rij}^{d} ( {S}_{i}^{h} ) [ \frac{{k}_{rij}^{i} ( {S}_{i}^{l} )}{{k}_{rij}^{d} ( {S}_{i}^{e} )} ] \\ and & ( 15 ) \\ {\tilde{k}}_{rij} ( {S}_{i} ) = {k}_{rij}^{l} ( {S}_{i}^{l} ) + [ {k}_{rij}^{d} ( 0 ) - {k}_{rij}^{l} ( {S}_{i}^{i} ) ] [ \frac{{k}_{rij}^{d} ( {S}_{i}^{h} ) - {k}_{rij}^{d} ( {S}_{i}^{e} )}{{k}_{rij}^{d} ( 0 ) - {k}_{rij}^{d} ( {S}_{i}^{e} )} ] . & ( 16 )\end{matrix}$$

For Equations 15 and 16 the hysteresis saturation, Sᵢ^{h}, will start at the equivalent saturation, Sᵢ^{e}, and decrease to zero, Equations 13 and 16 will ensure that the relative permeability will approach the limiting scanning relative permeability curve's end-point value. Equations 14 and 15 ensure that the relative permeability becomes zero at the normalized saturation of zero.

Each phase property is made dependent on the phase's appropriate normalized saturation.

Miscibility. For processes that are miscible the capillary pressure and relative permeability are handled differently. The capillary pressure is scaled by the ratio of two IFT values. The reference IFT value corresponds to the input capillary pressure curve. The scaling factor is

$${f}_{ij}^{{P}_{c}} = {( \frac{{σ}_{ij}}{{σ}_{ij}^{r}} )}^{{l}_{ij}} , \qquad ( 17 )$$

where the exponent lᵢⱼ is a user defined constant. The representative capillary pressure is then

\hat{P}_{cij}=fᵢⱼ^{P}^{_{c}}·\tilde{P}_{cij}. (18)

Similarly, the representative relative permeability is

\hat{k}ᵣᵢⱼ=\tilde{k}ᵣᵢⱼ, fᵢⱼ^{η}>1

\hat{k}ᵣᵢⱼ=fᵢⱼ^{η}·\tilde{k}ᵣᵢⱼ+(1−fᵢⱼ^{η})·Sᵢ, fᵢⱼ^{η}≦1 (19)

where Sᵢ is the normalized saturation.

The two hydrocarbon and the two water end-point saturations for the two hydrocarbon-water systems must also be equal at equal interfacial tensions or miscibility. The following equations are applied to ensure consistency.

S̅_{irw}= S̅_{irw}^{m}±½(1−f_{go}^{η})| S̅_{grw}^{m}− S̅_{orw}^{m}|, (20)

and

S̅_{wri}= S̅_{wri}^{m}±½(1−f_{go}^{η})| S̅_{grw}^{m}− S̅_{orw}^{m}|, (21)

where i=g, o. For the gas residual ‘+’ applies when S̅_{grw}^{m}> S̅_{orw}^{m} and ‘−’ applies when S̅_{grw}^{m}≦ S̅_{orw}^{m}. The same logic is applied for the oil residual except with opposite signs.

### Three-Phase Formulation

The three-phase properties are based on representative two-phase properties, which are combined through a weighting scheme of the saturations to obtain the three-phase properties, see Reference 1. Each phase property is made dependent on its own normalized saturation to ensure consistency and zero relative permeability at and below the end-point saturation. Three sets of two-phase data are applied allowing variable end-point saturations within the three-phase space.

Based on the three gridblock-saturations and the six gridblocks' end-point saturations, the minimum and maximum saturations are determined for each phase. These values represent the bounds for which each phase is mobile. The minimum and maximum saturations of phase i are given by

$$\begin{matrix}{\overline{S}}_{m m} = \frac{{\overline{S}}_{j} {\overline{S}}_{irj} + {\overline{S}}_{k} {\overline{S}}_{irk} + {\overline{S}}_{irj} {\overline{S}}_{irk} ( {\overline{S}}_{i} - 1 )}{{\overline{S}}_{j} ( 1 - {\overline{S}}_{irk} ) + {\overline{S}}_{k} ( 1 - {\overline{S}}_{irj} )} and & ( 22 ) \\ {\overline{S}}_{imx} = \frac{{\overline{S}}_{j} {\overline{S}}_{kri} + {\overline{S}}_{k} {\overline{S}}_{jri} + {\overline{S}}_{jri} {\overline{S}}_{kri} ( {\overline{S}}_{i} - 1 )}{{\overline{S}}_{j} {\overline{S}}_{kri} + {\overline{S}}_{k} {\overline{S}}_{jri}} & ( 23 )\end{matrix}$$

where subscript i, j and k represents either the gas, oil or water phase, and i≠j≠k.

The gridblock saturations are then normalized by

$${S}_{i} = \frac{{\overline{S}}_{i} - {\overline{S}}_{imn}}{{\overline{S}}_{imx} - {\overline{S}}_{imn}} , i = g , o , w . \qquad ( 24 )$$

The three normalized saturations for a three-phase condition from Equation 24 do not necessarily sum to unity. However, at the two-phase boundary the normalized saturations do sum to unity.

Given the normalized saturations from Equation 24, six process direction dependent normalized hysteresis saturations are determined from either Equation 11 or 12 giving two normalized hysteresis saturation associated with each of the mirrored two-phase systems. Note, the two normalized hysteresis saturations for a particular phase need not be equal for the two two-phase systems. The six process direction dependent normalized hysteresis saturations are represented by

S_{g}^{h}, Sₒ^{h} and S_{w}^{h}, (25)

two for each phase.

These six normalized hysteresis saturations are then applied to obtain the representative phase property.

Depending on the functional dependence of the reference input data these values may need to be altered. For example, the gas phase's representative value for the gas-water system may use the oil-water data to represent the gas-water data. This is recommended for gas-oil systems that may become miscible and use tabulated data. If the reference oil-water properties are dependent on the water saturation then the normalized hysteresis gas saturation must be changed to hysteresis normalized water saturation by

\hat{Ŝ}_{w}^{h}=1−S_{g}^{h} (26)

prior to looking up the oil property from the oil-water system representing the gas property in the gas-water system.

Similarly for the oil phase, oil-water system, the normalized hysteresis oil saturation must be changed to

Ŝ_{w}^{h}=1−Sₒ^{h} (27)

to be compatible with the reference data. A similar situation may occur also for the oil property in the gas-oil system if the reference data is a function of gas saturation. In this case the oil phase normalized hysteresis saturation must be converted to

Ŝ_{g}^{h}=1−Sₒ^{h} (28)

to obtain the representative two-phase oil phase values.

The resulting six representative two-phase capillary pressure values are then (omitting the hat on S)

\tilde{P}_{cgo}(S_{g}^{h}), \tilde{P}_{cgo}(Sₒ^{h}), \tilde{P}_{cgw}(S_{g}^{h}),

\tilde{P}_{cgw}(S_{w}^{h}), \tilde{P}_{cow}(Sₒ^{h}), \tilde{P}_{cow}(S_{w}^{h}), (29)

and the six representative two-phase relative permeability values are

\tilde{k}_{rgo}(S_{g}^{h}), \tilde{k}_{rgw}(S_{g}^{h}), \tilde{k}_{rog}(Sₒ^{h}),

\tilde{k}_{row}(Sₒ^{h}), \tilde{k}_{rwg}(S_{w}^{h}), \tilde{k}_{rwo}(S_{w}^{h}). (30)

This procedure generates two representative capillary pressure values for each phase pair. The capillary pressure can therefore be dependent on either of the two phases, which in Reference 1 had to be selected by the user. Even though this gave increased flexibility to the user for better capillary pressure representation with respect to wettability, it also increased the demand on the user's competence.

The representative capillary pressure from Equation 29 may then be made dependent on interfacial tension through Equation 18. Similarly, the representative relative permeability may be made dependent on the interfacial tension or capillary number through Equation 19.

### Capillary Pressure Model of Reference 1

Based on the six representative values for capillary pressure of Equation 29 the user had to select the functional dependence of the representative capillary pressure to be applied. That is, the user had to select

either \tilde{P}_{cgo}(S_{g}^{h}) or \tilde{P}_{cgo}(Sₒ^{h}), and

either \tilde{P}_{cgw}(S_{g}^{h}) or \tilde{P}_{cgw}(S_{w}^{h}), and

either \tilde{P}_{cow}(Sₒ^{h}) or \tilde{P}_{cow}(S_{w}^{h}).

Once the selection is made, the model has to ensure consistency in capillary pressure at the two-phase boundary the capillary pressure must meet the criteria

P_{cgw}−P_{cgo}−P_{cow}=0. (31)

When representative values of the capillary pressures are determined, Equation 31 is not necessarily fulfilled using representative values and a residual R is obtained, hence

\hat{P}_{cgw}−\hat{P}_{cgo}−\hat{P}_{cow}=R. (32)

To satisfy Equation 31, the functions F, G and H are introduced having the property

F+G+H=1. (33)

The representative capillary pressures may then be modified by

P_{cgo}=\hat{P}_{cgo}+F·R, (34)

P_{cgw}=\hat{P}_{cgw}−G·R (35)

and

P_{cow}=\hat{P}_{cow}+H·R, (36)

fulfilling Equation 31.

The functions in Equation 33 are made dependent on saturation to meet the consistency criteria at the two-phase boundary. The actual form of these equations in the three-phase space is unknown and may be dependent on factors such as interfacial tension, wettability and possibly other factors. The functional form is obtained from Reference 1.

$$\begin{matrix}F = \frac{{δ}_{w} {\overline{S}}_{w}^{{α}_{w}}}{{\overline{S}}_{w}^{{α}_{w}} + {( 1 - {\overline{S}}_{w} )}^{{β}_{w}}} , & ( 37 ) \\ H = \frac{{δ}_{g} {\overline{S}}_{g}^{{α}_{g}}}{{\overline{S}}_{g}^{{α}_{g}} + {( 1 - {\overline{S}}_{g} )}^{{β}_{g}}} , and & ( 38 ) \\ G = 1 - F - H & ( 39 )\end{matrix}$$

is incorporated.

An alternative formulation for three-phase capillary pressure is outlined in the section below entitled “Saturation weighting of six representative capillary pressures”, starting on page 29. This formulation makes use of all six representative capillary pressures to set the gridblock capillary pressures for the pressure equation.

The phase pressures are related by

pₒ=p

p_{g}=p+P_{cgo}.

p_{w}=p−P_{cow} (40)

The three-phase relative permeabilities are determined by weighting the representative values by the gridblock saturations

$${k}_{ri} = \frac{{\overline{S}}_{j}}{{\overline{S}}_{j} + {\overline{S}}_{k}} {\hat{k}}_{rij} + \frac{{\overline{S}}_{k}}{{\overline{S}}_{j} + {\overline{S}}_{k}} {\hat{k}}_{rik} \qquad ( 41 )$$

where i=g,o,w and i≠j≠k.

This formulation of Reference 1 permits proper modeling of the two-phase mirror image of the three-phase process. Continuity is also ensured for processes going from a three-phase state to any two-phase state.

An alternative model for capillary pressure is developed based on saturation weighting of the six representative capillary pressures described above, which pertains to an embodiment of this invention.

### Hydrocarbon-Water Interfacial Tension

The hydrocarbon-water interfacial tension is modeled by

σ_{iw}=A(Δρ)²+BΔρ+C, i=g,o (42)

where A, B and C are user defined constants, and

Δρ=ρ_{w}−ρᵢ, i=g,o (43)

Note, Equation 43 assumes the water density to be greater than the hydrocarbon density.

### Saturation Weighting of Six Representative Capillary Pressures

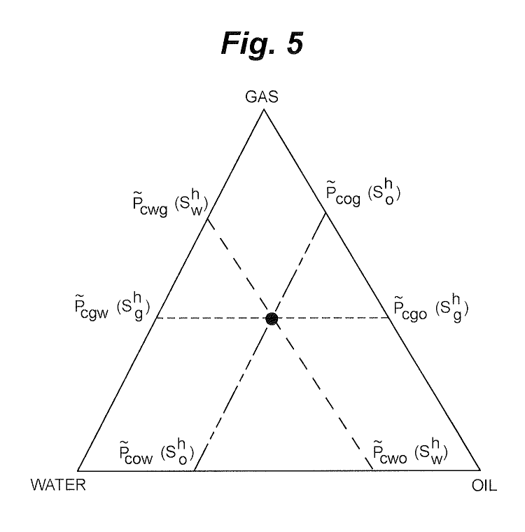

In Reference 1, the concept of “representative” capillary pressures is described. Each representative two-phase capillary pressure can be made dependent on one of the two saturations. At the two-phase boundary these two representative values are equivalent. As the saturations move into the three phase region and away from the two-phase boundary, the two saturation-dependent representative capillary pressures will deviate from one another; see FIG. 5 for an illustration of the saturation dependence, which shows a ternary diagram for three phase conditions with the six representative capillary pressures as depicted.

The six representative capillary pressures may be weighted by the gridblock normalized saturations as follows.

$$\begin{matrix}PCG = \frac{{S}_{o}}{{S}_{o} + {S}_{w}} {\tilde{P}}_{cgo} ( {S}_{g}^{h} ) + \frac{{S}_{w}}{{S}_{o} + {S}_{w}} {\tilde{P}}_{cgw} ( {S}_{g}^{h} ) & ( 44 ) \\ PCO = \frac{{S}_{g}}{{S}_{g} + {S}_{w}} {\tilde{P}}_{cgo} ( {S}_{o}^{h} ) + \frac{{S}_{w}}{{S}_{g} + {S}_{w}} {\tilde{P}}_{cow} ( {S}_{o}^{h} ) & ( 45 ) \\ PCW = \frac{{S}_{g}}{{S}_{g} + {S}_{o}} {\tilde{P}}_{cgw} ( {S}_{w}^{h} ) + \frac{{S}_{o}}{{S}_{g} + {S}_{o}} {\tilde{P}}_{cow} ( {S}_{w}^{h} ) & ( 46 )\end{matrix}$$

Where the Sᵢ, i=g,o,w, represents the normalized saturations. Equations 44 through 46 can also be written so to relate to the phase pressures used in the pressure equation or transport equations:

(Sₒ+S_{w})PCG=Sₒ(p_{g}−pₒ)+S_{w}(p_{g}−p_{w}) (47)

(S_{g}+S_{w})PCO=S_{g}(p_{g}−pₒ)+S_{w}(pₒ−p_{w}) (48)

(S_{g}+Sₒ)PCW=S_{g}(p_{g}−p_{w})+Sₒ(pₒ−p_{w}) (49)

or

$$[ \begin{matrix}( {S}_{o} + {S}_{w} ) PCG \\ ( {S}_{g} + {S}_{w} ) PCO \\ ( {S}_{g} + {S}_{o} ) PCW\end{matrix} ] = [ \begin{matrix}{S}_{o} + {S}_{w} & - {S}_{o} & - {S}_{w} \\ {S}_{g} & {S}_{w} - {S}_{g} & - {S}_{w} \\ {S}_{g} & {S}_{o} & - {S}_{g} - {S}_{o}\end{matrix} ] [ \begin{matrix}{p}_{g} \\ {p}_{o} \\ {p}_{w}\end{matrix} ] \qquad ( 50 )$$

Solving Equation 50 results in the solutions for pₒ−p_{w}

$$\begin{matrix}{p}_{o} - {p}_{w} = \frac{( {S}_{g} + {S}_{w} ) PCO - ( {S}_{g} + {S}_{w} ) ( {S}_{g} + {S}_{w} ) PCW}{( {S}_{w} - {S}_{o} - {S}_{g} )} \\ = \frac{{S}_{g} ( {\tilde{P}}_{cgo} ( {S}_{o}^{h} ) - {\tilde{P}}_{cgw} ( {S}_{w}^{h} ) ) - {S}_{w} {\tilde{P}}_{cow} ( {S}_{o}^{h} ) - {S}_{o} {\tilde{P}}_{cow} ( {S}_{w}^{h} )}{( {S}_{w} - {S}_{o} - {S}_{g} )}\end{matrix} \qquad ( 51 )$$

and p_{g}−pₒ becomes

$$\begin{matrix}{p}_{g} - {p}_{o} = \frac{- ( {S}_{o} + {S}_{w} ) PCG + ( {S}_{g} + {S}_{w} ) PCO}{( {S}_{g} - {S}_{o} - {S}_{w} )} \\ = \frac{\begin{matrix}{S}_{g} {\tilde{P}}_{cgo} ( {S}_{o}^{h} ) - {S}_{o} {\tilde{P}}_{cgo} ( {S}_{g}^{h} ) + \\ {S}_{w} ( {\tilde{P}}_{cow} ( {S}_{o}^{h} ) - {\tilde{P}}_{cgw} ( {S}_{g}^{h} ) )\end{matrix}}{{S}_{g} - {S}_{o} - {S}_{w}}\end{matrix} \qquad ( 52 )$$

These capillary pressures take on different forms at the two and single phase boundaries. If S_{g}≦0, Sₒ>0 and S_{w}>0 then solving Equation 50 gives

$$\begin{matrix}{p}_{o} - {p}_{w} = {\tilde{P}}_{cow} ( {S}_{o}^{h} ) and & ( 53 ) \\ {p}_{g} - {p}_{o} = \frac{{S}_{o}}{{S}_{o} + {S}_{w}} {\tilde{P}}_{cgo} ( {S}_{g}^{h} ) + \frac{{S}_{w}}{{S}_{o} + {S}_{w}} ( {\tilde{P}}_{cgw} ( {S}_{g}^{h} ) - {\tilde{P}}_{cow} ( {S}_{o}^{h} ) ) & ( 54 )\end{matrix}$$

Notice that the oil-water capillary pressure is a function of hysteresis oil saturation and not hysteresis water saturation. The gas-oil capillary pressure is not necessarily zero, but dependent on the representative gas-oil capillary pressure end-point value (often zero if non-wetting) and saturation weighted representative oil-water capillary pressure.

It is useful to consider how these phase pressures relate to capillary pressure at the two-phase boundary:

For Sₒ≦0, S_{g}>0 and S_{w}>0 one obtains

$$\begin{matrix}{p}_{o} - {p}_{w} = \frac{{S}_{g}}{{S}_{w} - {S}_{g}} [ {\tilde{P}}_{cgo} ( {S}_{o}^{h} ) - {\tilde{P}}_{gw} ( {S}_{g}^{h} ) ] + \frac{{S}_{w}}{{S}_{w} - {S}_{g}} {\tilde{P}}_{cow} ( {S}_{o}^{h} ) \\ and & ( 55 ) \\ {p}_{g} - {p}_{o} = \frac{{S}_{g}}{{S}_{g} - {S}_{w}} {\tilde{P}}_{cgo} ( {S}_{o}^{h} ) + \frac{{S}_{w}}{{S}_{g} - {S}_{w}} ( {\tilde{P}}_{cow} ( {S}_{o}^{h} ) - {\tilde{P}}_{cgw} ( {S}_{g}^{h} ) ) . & ( 56 )\end{matrix}$$

For S_{w}≦0, S_{g}>0 and Sₒ>0 one obtains

$$\begin{matrix}{p}_{o} - {p}_{w} = \frac{{S}_{o}}{{S}_{g} + {S}_{o}} {\tilde{P}}_{cow} ( {S}_{w}^{h} ) + \frac{{S}_{g}}{{S}_{g} + {S}_{o}} ( {\tilde{P}}_{cgw} ( {S}_{w}^{h} ) - {\tilde{P}}_{cgo} ( {S}_{g}^{h} ) ) \\ and & ( 57 ) \\ {p}_{g} - {p}_{o} = {\tilde{P}}_{cgo} ( {S}_{g}^{h} ) . & ( 58 )\end{matrix}$$

Similarly, for S_{g}>0, Sₒ≦0 and S_{w}≦0, then

pₒ−p_{w}=\tilde{P}_{cgw}(S_{w}^{h})−\tilde{P}_{cgo}(Sₒ^{h}) (59)

p_{g}−pₒ=\tilde{P}_{cgo}(Sₒ^{h}), (60)

and for Sₒ>0, S_{g}≦0 and S_{w}≦0, then

pₒ−p_{w}=\tilde{P}_{cow}(S_{w}^{h}), (61)

p_{g}−pₒ=\tilde{P}_{cgo}(S_{g}^{h}), (62)

and for S_{w}>0, S_{g}≦0 and Sₒ≦0, then

pₒ−p_{w}=\tilde{P}_{cow}(Sₒ^{h}), (63)

p_{g}−pₒ=\tilde{P}_{cgw}(S_{g}^{h})−\tilde{P}_{cow}(Sₒ^{h}). (64)

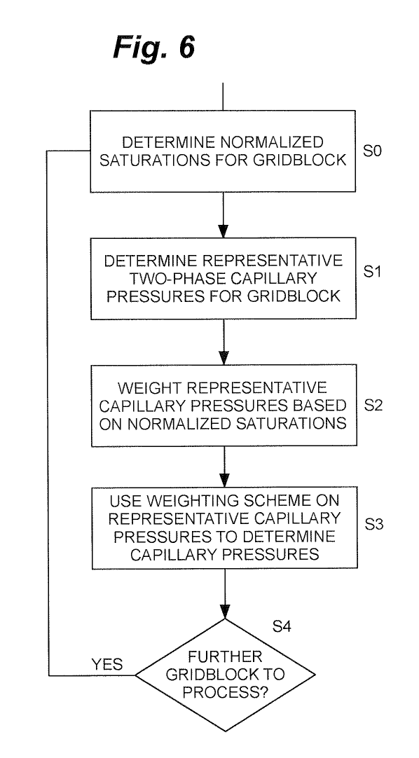

A method according to an embodiment of the present invention can be summarized by the steps as represented in the flowchart of FIG. 6, which illustrates schematically the steps in a method according to an embodiment of the present invention of determining capillary pressures in a fluid reservoir comprising three phases g, o and w. The reservoir is considered as comprising a plurality of gridblocks, and for each gridblock of the reservoir (for each time step): in step S0 normalized saturations are determined; in step S1 six representative two-phase capillary pressures are determined; in step S2 the representative capillary pressures are weighted based on saturation; and in step S3 the weighted representative capillary pressures are used to determine at least two of the three capillary pressures g-o, o-w and g-w. In step S3 the two former determined capillary pressures (g-o and o-w) would typically be used in solving a pressure equation in a reservoir simulator, the solving of the pressure equation enabling the determination of a physical property of the reservoir, such as a saturation profile for each of the three phases. In step S4 it is determined whether there are any further gridblocks to process, and if so then processing returns to step S1 for the next gridblock. FIG. 6 can also be considered to represent a block diagram of apparatus according to an embodiment of the present invention, comprising four portions for performing respectively the four steps S0 to S3 as set out above, and a decision making portion for carrying out the decision of step S4.

### EXAMPLES AND DISCUSSIONS

The 1D example from Reference 1 is revisited below.

### ID Homogeneous Example

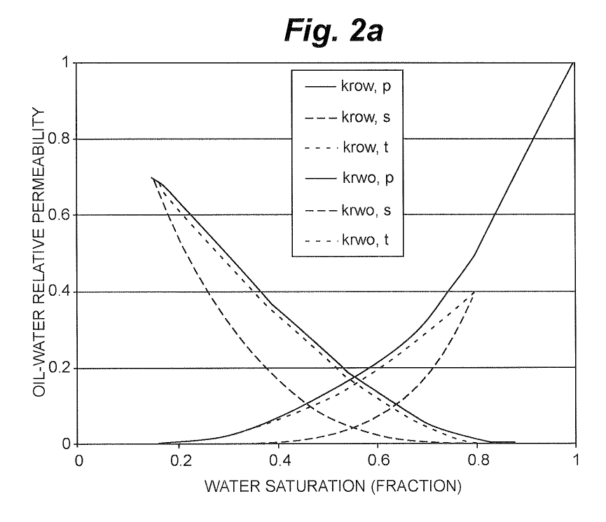

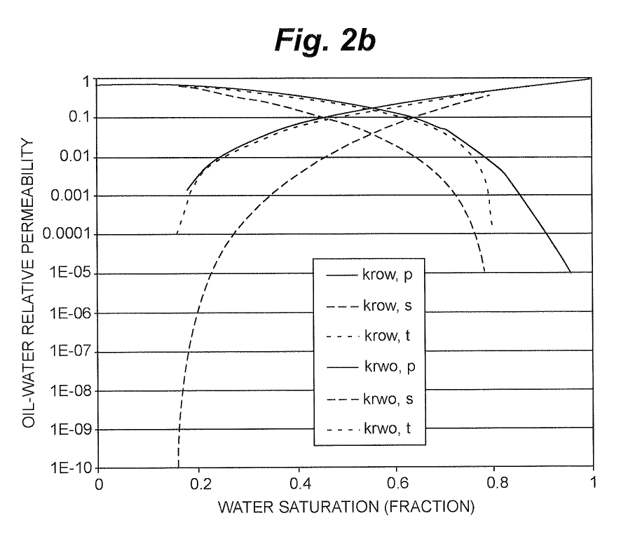

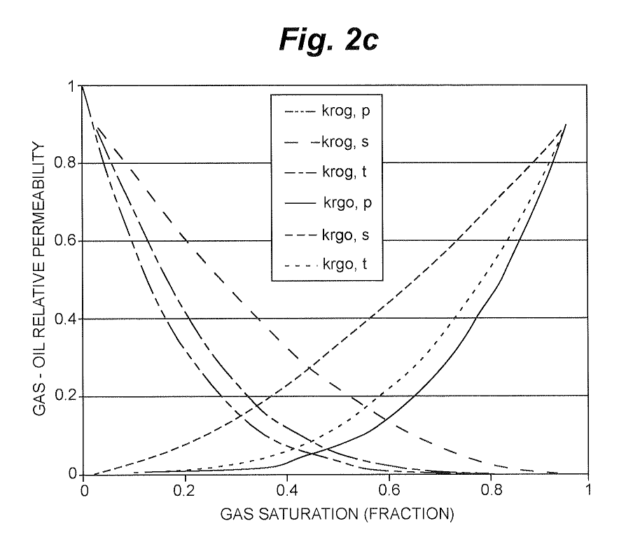

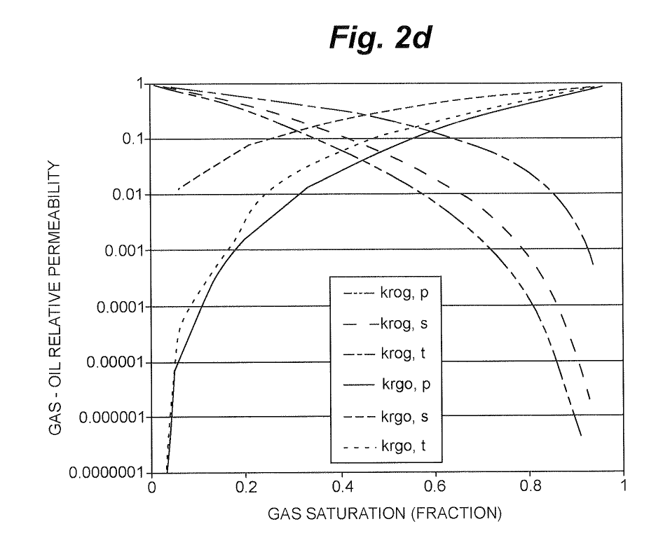

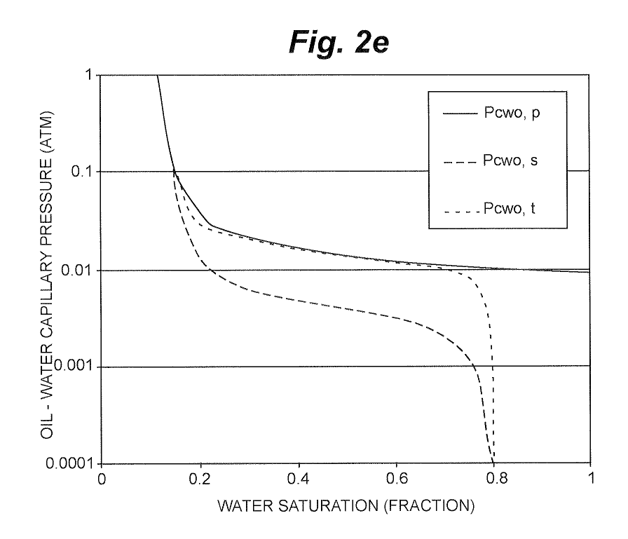

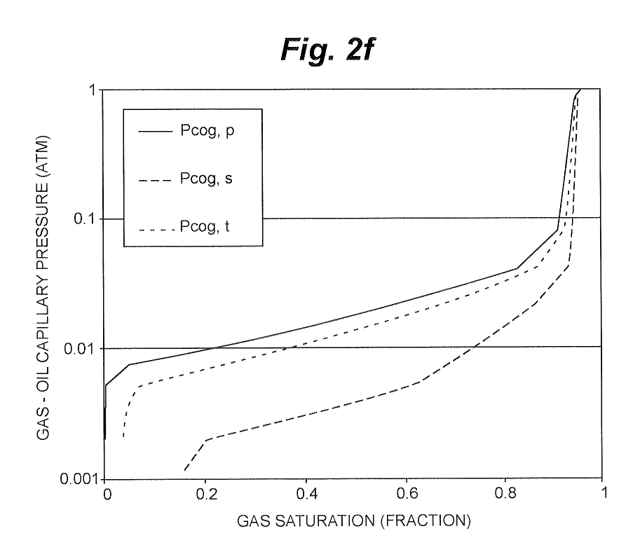

The assumption is made that the immiscible flooding process occurs horizontally along the ID segment of an oil column. The model parameters are listed in Table 2 below (page 40). The saturation functions are shown in FIG. 2. Detailed input data are listed in the Appendix starting on page 38. The saturation functions are typical water-wet functions where the following functional dependence of capillary pressure on saturation as described for the model in Table 1 has been applied (IPCFN=6):

\tilde{P}_{cgo}(S_{g}^{h}), \tilde{P}_{cgw}(S_{w}^{h}), and \tilde{P}_{cow}(S_{w}^{h}). (65)

The constants of Equations 37 and 38 are all set to zero. The reference and threshold IFTs are listed in Table 2.

The producing well is located in the last gridblock (100), the water injector is located in the second gridblock and the gas injector in the first gridblock. The production well is kept at constant bottom-hole pressure (BHP) of 347.3 bar and the injection wells are kept at constant reservoir injection rates of 10 cm³/h.

The reservoir oil (and gas) is modeled by the Soave-Redlich-Kwong equation of state, and the model parameters are those of the Appendix Table 3 below starting on page 38 taken from Reference 14. The injection gas is the equilibrium gas composition at the bubble point pressure.

Alternating equal reservoir volumes of water and gas in cycles of 15 hours each flood the ID segment. Hence 15% of the segment's total pore volume is flooded by each injection cycle. The segment is first flooded by water, followed by gas, then water and so on.

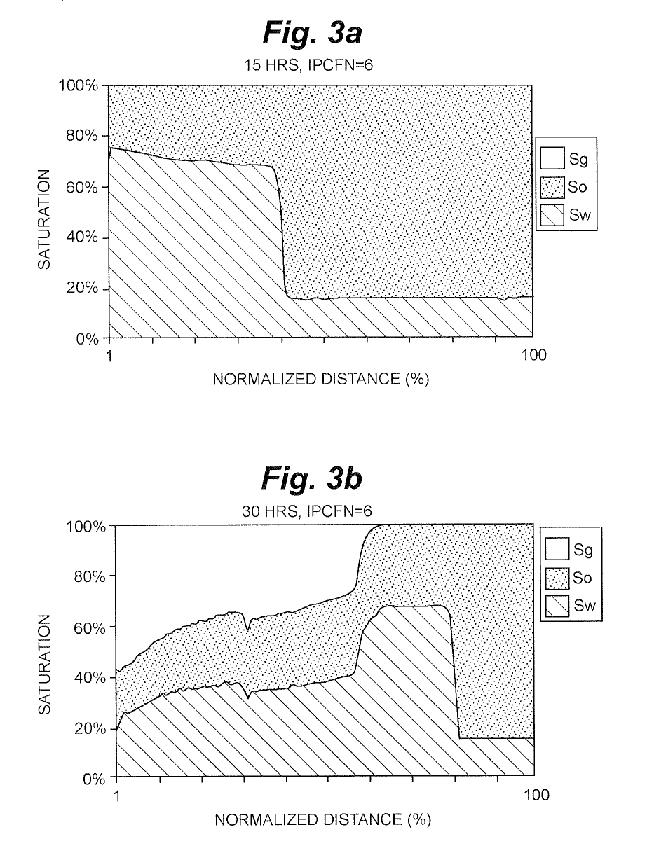

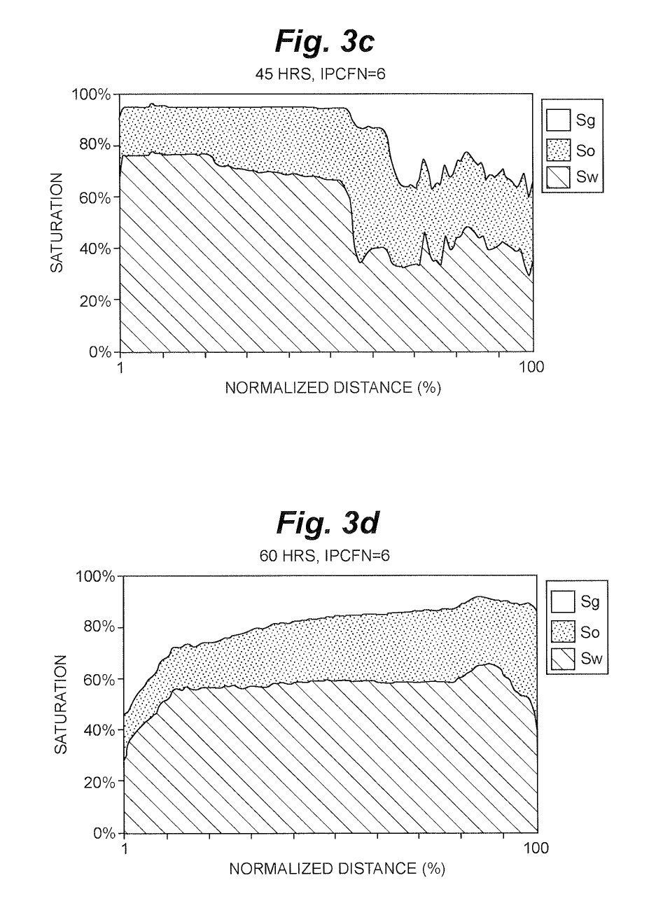

FIG. 3 illustrates resulting saturation profiles for the 1D example at the end of each injection cycle. FIGS. 3a to 3d show different saturation profiles than Reference 1 and this is mainly due to the scaling procedure applied to the capillary pressure, relative permeability and end-point saturations.

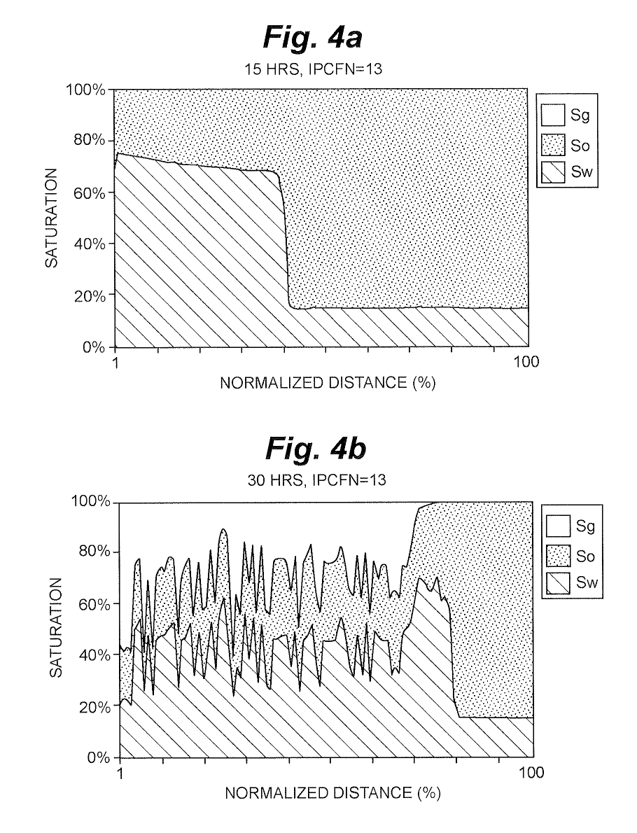

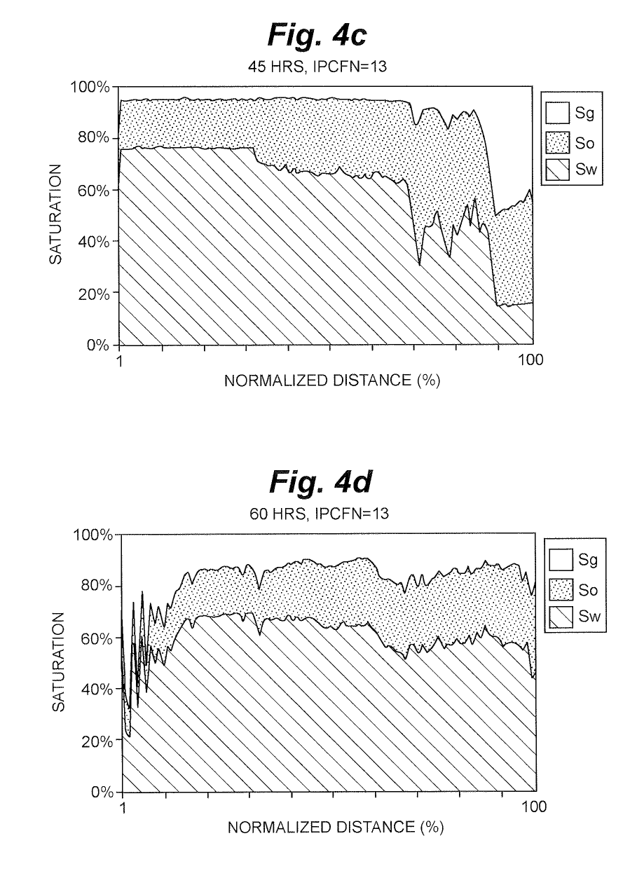

Depending of the functional relations chosen jagged saturation profiles may occur as illustrated in FIG. 9b of Reference 1 (and FIG. 4b described below). The jaggedness is caused by several factors that are dependence on the process with time. The jagged profiles do not impact the numerical performance of the simulator. The derivatives of capillary pressure with respect to space are not appropriately accounted for in the difference scheme (or pressure equation). The example illustrated is 1D which does not account for gravitational forces. The gravitational force counteracts the capillary force. The gas phase's mobility is much higher than the liquid phases due to its low viscosity and with the strong capillary forces acting on the liquid phases create a form for instability in space rendering the illustrated fluid distribution.

The present invention determines the capillary pressures in such a way making them dependent on all saturations and all representative capillary pressures. The procedure is such that it does not require a pre-definition of the capillary pressure's dependence on saturation.

Applying all six representative capillary pressure values in a saturation weighting scheme as described in the section above entitled “Saturation weighting of six representative capillary pressures” (IPCFN=13) have been conducted. This formulation reveals that at the two-phase and single-phase boundary the three-phase capillary pressures to be applied in the pressure equation is not what one would intuitive expect. The idea underlying an embodiment of the present invention is to use all six representative capillary pressure values in order to determine the phase pressures. The six representative capillary pressures are weighted by the saturations making the capillary pressure dependent on all three saturations when three phases are present. The phase pressures are then determined and used to set the gas-oil and oil-water capillary pressures for use in the pressure equation.

Applying this formulation, FIG. 4 shows that the saturation profiles to be different than the formulation described in Reference 1 and above.

Within the contexts of a consistent and coupled three-phase capillary pressure and relative permeability model for reservoir simulation (Reference 1) a new model for capillary pressure has been devised that make use of six representative two-phase capillary pressure values to set two capillary pressure values required for the solution of the pressure equation (or transport equations).

A capillary pressure model executable according to an embodiment of the present invention eliminates the requirement for a user to specify the saturation dependence of the two-phase capillary pressure for three-phase conditions.

Test examples have been simulated with the former and new capillary pressure models. The examples consisted of typical capillary pressure and relative permeability data for a typical water-wet system. The saturation profiles from the simulations show that the saturation dependency of the capillary pressures has an impact on the simulated saturation profiles and recoveries. A capillary pressure model executable according to an embodiment of the present invention produces significantly higher residual saturations and lower recoveries compared to the former model of Reference 1.

The use of six representative capillary pressures, making capillary pressures dependent on all saturations, rather than the more traditional single saturation dependent functions to model fluid flow in porous media offers a flexible and more sophisticated approach to the modeling complex reservoir behavior with dynamic varying properties including hysteresis and IFT scaling of saturation functions.

It will be appreciated that operation of one or more of the above-described components or method steps can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

### REFERENCES

1. Hustad, O. S.: “A Coupled Model for Three-Phase Capillary Pressure and Relative Permeability,” SPE Journal, March 2002.
2. Ahmed, Tarek: Reservoir Engineering Handbook, Third Edition, Elsevier, 2006.
3. Honarpour, M., Koederitz, L. and Harvey, A. H.: Relative Permeability of Petroleum Reservoirs, CRC Press, Inc. (1986).
4. Aziz, K. and Settari, A.: Petroleum Reservoir Simulation, Applied Science Publishers Ltd., London (1979).
5. Mattax, C. C. and Dalton, R. L.: Reservoir Simulation. SPE Monograph Series, Vol. 13, Richardson, Tex. (1990).
6. Skjæveland, S. M. and Kleppe, J. (eds.): Recent Advances in Improved Oil Recovery Methods for North Sea Sandstone Reservoirs, SPOR Monograph, Norwegian Petroleum Directorate, Stavanger (1992).
7. Hustad, O. S. and Holt, T.: “Gravity Stable Displacement of Oil by Hydrocarbon Gas after Water flooding,” paper SPE/DOE 24116 in proceedings of the SPE/DOE Eighth Symposium on Enhanced Oil Recovery, Tulsa (Apr. 22-24, 1992) 131-146.
8. Stone, H. L.: “Probability Model for Estimating Three-Phase Relative Permeability,” Trans. SPE of AIME, 249, JPT (February 1970) 214-218.
9. Stone, H. L.: “Estimation of Three-Phase Relative Permeability and Residual Oil Data,” J. Cdn. Pet. Tech. (October-December 1973) 53-61.
10. Skjæveland, S. M., Skauge, A., Hinderaker, L. and Sisk, C. D. (eds.): RUTH—A Norwegian Research Program on Improved Oil Recovery, Program Summary, Norwegian Petroleum Directorate, Stavanger (1996), pp. 183-194 and 195-201.
11. Hinderaker, L., Utseth, R. H., Hustad, O. S., Akervoll, I., Dalland, M., Kvanvik, B. A., Austad, T. and Paulsen, J. E.: “RUTH—A Comprehensive Norwegian R&D Program on IOR,” paper SPE 36844-MS presented at the European Petroleum Conference, Milan (22-24 Oct. 1996).
12. Hustad, O. S., Kløv, T., Lerdahl, T. R., Berge, L. I., Stensen, J. Å. and Øren, P.-E.: “Gas Segregation During WAG Injection and the Importance of Parameter Scaling in Three-Phase Models,” paper SPE 75138 presented at the SPE/DOE Thirteenth Symposium on Improved Oil Recovery, Tulsa, 13-17 Apr. 2002.
13. Oak, M. J., Baker, L. E. and Thomas, D. C.: “Three-Phase Relative Permeability of Berea Sandstone,” JPT (August 1990) 1054-1061.
14. Hustad, O. S. and Dalen, V.: “An Explicit Phase-Behaviour Model for Pseudocompositional Reservoir Simulation,” SPE Advanced Technology Series (1993) 1, No. 1, 17.

### Appendix

TABLE 1
Reference Saturation Functions
Oil-Water Data

| | Primary S_{w} | | | Increasing S_{w} | | | Decreasing S_{w} | | |
|---|---|---|---|---|---|---|---|---|---|
| P_{cow} | S_{w} | k_{rwo,p} | k_{row,p} | S_{w} | k_{rwo,s} | k_{row,s} | S_{w} | k_{rwo,t} | k_{row,t} |
| 10.0 | 0.15 | 0.0 | 0.7 | 0.15 | 0.0 | 0.7 | 0.15 | 0.0 | 0.7 |
| 0.05 | 0.18 | 0.0015 | 0.67 | 0.1501 | 3.447E−20 | 0.699677 | 0.16 | 9.467E−5 | 0.683908 |
| 0.04 | 0.2 | 0.003 | 0.64 | 0.16 | 3.447E−10 | 0.668187 | 0.18 | 0.000852 | 0.652102 |
| 0.03 | 0.22 | 0.006 | 0.61 | 0.17 | 1.103E−8 | 0.637352 | 0.2 | 0.002367 | 0.620805 |
| 0.026 | 0.24 | 0.009 | 0.58 | 0.175 | 3.367E−8 | 0.622297 | 0.22 | 0.004639 | 0.590024 |
| 0.022 | 0.29 | 0.02 | 0.51 | 0.18 | 8.377E−8 | 0.607481 | 0.269 | 0.013407 | 0.516856 |
| 0.017 | 0.39 | 0.06 | 0.37 | 0.19 | 3.53E−7 | 0.578559 | 0.374 | 0.047504 | 0.3714 |
| 0.013 | 0.54 | 0.16 | 0.19 | 0.2 | 1.077E−6 | 0.550569 | 0.523 | 0.13172 | 0.194737 |
| 0.0115 | 0.635 | 0.24 | 0.106 | 0.208 | 2.263E−6 | 0.528839 | 0.615 | 0.20471 | 0.106288 |
| 0.011 | 0.7 | 0.32 | 0.05 | 0.212 | 3.158E−6 | 0.518191 | 0.647 | 0.233855 | 0.07994 |
| 0.0104 | 0.8 | 0.5 | 0.007 | 0.217 | 4.654E−6 | 0.505084 | 0.68 | 0.265941 | 0.055526 |
| 0.009 | 1.0 | 1.0 | 0.0 | 0.24 | 2.036E−5 | 0.447633 | 0.739 | 0.328446 | 0.020124 |
| 0.0079 | 1.0 | 1.0 | 0.0 | 0.254 | 4.194E−5 | 0.414893 | 0.756 | 0.347679 | 0.012328 |
| 0.0067 | 1.0 | 1.0 | 0.0 | 0.28 | 0.000128 | 0.3584 | 0.767 | 0.360416 | 0.008008 |
| 0.0057 | 1.0 | 1.0 | 0.0 | 0.304 | 2.986E−4 | 0.311031 | 0.774 | 0.36864 | 0.0056 |
| 0.005 | 1.0 | 1.0 | 0.0 | 0.39 | 0.002745 | 0.175675 | 0.779 | 0.374571 | 0.004065 |
| 0.0043 | 1.0 | 1.0 | 0.0 | 0.467 | 0.011035 | 0.094122 | 0.784 | 0.38055 | 0.002703 |
| 0.00337 | 1.0 | 1.0 | 0.0 | 0.58 | 0.05068 | 0.027141 | 0.789 | 0.386576 | 0.001541 |
| 0.00244 | 1.0 | 1.0 | 0.0 | 0.674 | 0.136191 | 0.005099 | 0.792 | 0.390214 | 9.558E−4 |
| 0.0022 | 1.0 | 1.0 | 0.0 | 0.69 | 0.158293 | 0.003393 | 0.793 | 0.391431 | 7.823E−4 |
| 0.00132 | 1.0 | 1.0 | 0.0 | 0.7454 | 0.257951 | 0.000415 | 0.7956 | 0.394603 | 3.899E−4 |
| 0.00074 | 1.0 | 1.0 | 0.0 | 0.77 | 0.315829 | 6.882E−5 | 0.7975 | 0.396929 | 1.67E−4 |
| 0.0 | 1.0 | 1.0 | 0.0 | 0.8 | 0.4 | 0.0 | 0.8 | 0.4 | 0.0 |

Gas-Oil Data

| | Primary S_{g} | | | Decreasing S_{g} | | | Increasing S_{g} | | |
|---|---|---|---|---|---|---|---|---|---|
| P_{cgo} | S_{g} | k_{rgo,p} | k_{rog,p} | S_{g} | k_{rgo,s} | k_{rog,s} | S_{g} | k_{rgo,t} | k_{rog,t} |
| 0.0 | 0.0001 | 0.0 | 1.0 | 0.03 | 0.0 | 0.9 | 0.03 | 0.0 | 0.9 |
| 0.002 | 0.00034 | 1.416E−14 | 0.99823 | 0.2009 | 0.070898 | 0.599618 | 0.0358 | 2.183E−7 | 0.877758 |
| 0.0028 | 0.00049 | 6.109E−11 | 0.997451 | 0.35 | 0.181653 | 0.387201 | 0.04 | 1.119E−6 | 0.86191 |
| 0.0036 | 0.00078 | 3.922E−13 | 0.995944 | 0.48 | 0.302926 | 0.23975 | 0.0434 | 2.692E−6 | 0.849239 |
| 0.0052 | 0.00233 | 3.123E−11 | 0.987923 | 0.62 | 0.454774 | 0.120291 | 0.0679 | 6.091E−5 | 0.762017 |
| 00.00768 | 0.05 | 6.623E−6 | 0.765334 | 0.69 | 0.538064 | 0.075858 | 0.236 | 0.009781 | 0.330571 |
| 0.009 | 0.13 | 3.026E−4 | 0.483097 | 0.72 | 0.575164 | 0.059938 | 0.315 | 0.025902 | 0.208233 |
| 0.01 | 0.2 | 0.001695 | 0.310965 | 0.74 | 0.600352 | 0.050364 | 0.382 | 0.0488 | 0.134283 |
| 0.012 | 0.31 | 0.009786 | 0.142302 | 0.77 | 0.638801 | 0.037565 | 0.44 | 0.077116 | 0.087968 |
| 0.014 | 0.38 | 0.022095 | 0.080498 | 0.8 | 0.678038 | 0.026639 | 0.5 | 0.116168 | 0.053869 |
| 0.02 | 0.54 | 0.090102 | 0.016028 | 0.85 | 0.745142 | 0.012591 | 0.632 | 0.244109 | 0.013925 |
| 0.024 | 0.62 | 0.156576 | 0.005572 | 0.876 | 0.780861 | 0.007342 | 0.71 | 0.35182 | 0.0047 |
| 0.03 | 0.71 | 0.269272 | 0.001198 | 0.9 | 0.814323 | 0.003746 | 0.782 | 0.475825 | 0.001208 |
| 0.041 | 0.83 | 0.502886 | 4.554E−5 | 0.93 | 0.856805 | 9.365E−4 | 0.873 | 0.670311 | 6.893E−5 |
| 0.055 | 0.91 | 0.726646 | 3.833E−7 | 0.94 | 0.871124 | 4.162E−4 | 0.925 | 0.802163 | 1.805E−6 |
| 10.0 | 0.96 | 0.9 | 0.0 | 0.96 | 0.9 | 0.0 | 0.96 | 0.9 | 0.0 |

TABLE 2
Data used in 1D examples

| Parameter | Value |
|---|---|
| Permeability (mD) | 500 |
| Porosity (%) | 25 |
| Length (cm) | 1000 |
| Pore Volume (cm³) | 1000 |
| Initial water volume (cm³) | 151 |
| Initial pressure (bar) | 347.3 |
| Average fluid densities g/o/w (g/cm³) | 0.2865/0.5196/0.9550 |
| Average fluid viscosities g/o/w (cP) | 0.0364/0.1460/0.3050 |
| Reference IFTs go/gw/ow (mN/m) | 0.07375/27.371/27.371 |
| Threshold IFTs go/gw/ow (mN/m) | 0.07375/1.0/1.0 |
| Average IFTs go/gw/ow (mN/m) | 0.07635/27.37/23.28 |
| Hydrocarbon-water IFT constants A/B/C, Eq. 42 | 20/1/15 |
| All exponent terms in Eqs. 4, 5 & 17 | 1 |
| Rock compressibility (bar⁻¹) | 7.0 · 10⁻⁵ |
| Water compressibility (bar⁻¹) | 5.0 · 10⁻⁴ |
| Reservoir temperature (° C.) | 140 |
| S_{gro}^{pr} | 0.0001 |
| S_{gro}^{hr} | 0.03 |
| S_{grw}^{pr} | 0.0001 |
| S_{grw}^{hr} | 0.06 |
| S_{org}^{pr} = S_{org}^{hr} | 0.04 |
| S_{orw}^{pr} | 0.0 |
| S_{orw}^{hr} | 0.2 |
| S_{wrg}^{pr} = S_{wrg}^{hr} | 0.05 |
| S_{wro}^{pr} = S_{wro}^{hr} | 0.15 |

TABLE 3
SRK EOS Parameters and compositions

| | | | | | Acentric | Mole % | Mole % |
|---|---|---|---|---|---|---|---|
| Comp. ID | MW (g/mol) | P_{c} (Bar) | V_{c} (cm³/mol) | T_{c} (K) | Factor | Oil | Inj. Gas |
| N₂ | 28.02 | 33.94 | 89.89 | 126.2 | 0.04 | 0.69 | 1.15955 |
| CO₂ | 44.01 | 73.76 | 93.96 | 304.2 | 0.225 | 3.14 | 3.7708 |
| C₁ | 16.04 | 46.0 | 99.25 | 190.6 | 0.008 | 52.8 | 70.378 |
| HC₂₋₃ | 35.88 | 45.59 | 170.71 | 338.2 | 0.1255 | 15.15 | 14.5266 |
| HC₄₋₆ | 67.98 | 34.25 | 294.27 | 456.95 | 0.2325 | 7.03 | 4.87286 |
| C₈ | 110.14 | 30.01 | 492.06 | 575.51 | 0.421 | 8.67 | 3.50881 |
| HC₁₃ | 173.11 | 22.3 | 800.8 | 666.13 | 0.7174 | 5.29 | 1.20064 |
| HC₁₈ | 248.85 | 16.18 | 1218.0 | 735.04 | 0.9849 | 3.4 | 0.426403 |
| HC₂₆ | 361.77 | 11.88 | 1821.0 | 807.07 | 1.2737 | 2.38 | 0.14229 |
| HC₄₃ | 600.98 | 10.27 | 2388.0 | 914.84 | 1.6704 | 1.45 | 0.0140679 |

Non-zero Binary Interaction Parameters

| | CO₂ | C₁ | HC₂₋₃ | HC₄₋₆ | C₈ | HC₁₃ | HC₁₈ | HC₂₆ | HC₄₃ |
|---|---|---|---|---|---|---|---|---|---|
| N₂ | −0.055 | 0.028 | 0.0 | 0.08 | 0.08 | 0.08 | 0.08 | 0.08 | 0.08 |
| CO₂ | | 0.12 | 0.15 | 0.15 | 0.15 | 0.15 | 0.15 | 0.15 | 0.15 |

### Nomenclature

A—User specified constant for HC-water IFT
B—User specified constant for HC-water IFT
C—User specified constant for HC-water IFT
F—Correction function for gas-oil capillary pressure
fᵢⱼ^{η} Scaling function for end-point saturations and relative permeability
fᵢⱼ^{P}^{_{c}} Scaling function for capillary pressure
G—Correction function for gas-water capillary pressure
H—Correction function for oil-water capillary pressure
\check{k}ᵣᵢⱼ—Input relative permeability to phase i presence of phase j
\tilde{k}ᵣᵢⱼ—Representative relative permeability to phase i
\hat{k}ᵣᵢⱼ—IFT scaled representative relative permeability
nᵢⱼ—User specified exponent constant for end-point saturation and relative permeability scaling function, i,j=g,o,w and i≠j
P_{cij}—Capillary pressure for phases i and j
\check{P}_{cij}—Input capillary pressure for phases i and j
\tilde{P}_{cij}—Representative capillary pressure
\hat{P}_{cij}—IFT scaled representative capillary pressure
p—Pressure
R—Capillary pressure constraint residual
S—Normalized saturation (input or gridblock)
Sᵢ^{3h}—Normalized saturation based on hysteresis end-point saturations only
\check{S}—Input saturation
S̅—Gridblock saturation
\dot{S}—Saturation derivative with respect to time
u—Darcy velocity
αᵢ—User specified constant, i=g,w
βᵢ—User specified constant, i=g,w
δᵢ—User specified constant, i=g,w
μ—Viscosity
ρ—Mass density
σᵢⱼ—Interfacial tension between phases i and j

### Subscripts

g—Gas
gro—Gas end-point in the presence of oil
grw—Gas end-point in the presence of water
imn—Minimum for phase i
imx—Maximum for phase i
o—Oil
org—Oil end-point in the presence of gas
orw—Oil end-point in the presence of water
w—Water
wrg—Water end-point in the presence of gas
wro—Water end-point in the presence of oil

### Superscripts

d—Decreasing
e—Equivalent
h—Hysteresis
i—Increasing
m—Scaled
max—Maximum
p—Primary
pr—Primary reference
hr—Hysteresis reference
r—Reference
t—Turning point
th—Threshold
η—IFT or N_{c}
κ—pr or hr

1. A method of determining capillary pressures in a fluid reservoir comprising three phases g, o and w, the reservoir being considered as comprising a plurality of gridblocks, the method comprising:
receiving input data representing characteristics of the fluid reservoir; and
for each gridblock of the reservoir
transforming the input data into six representative two-phase capillary pressures, the representative capillary pressures being weighted based on saturation;
transforming the weighted representative capillary pressures into at least two of the three capillary pressures g-o, o-w and g-w; and
outputting the at least two capillary pressures as output data.

2. The method of claim 1, wherein the three phases g, o and w are gas, oil and water respectively.

3. The method of claim 2, further comprising:
using the weighted representative capillary pressures to determine the gas-oil and oil-water capillary pressures.

4. The method of claim 1, further comprising:
using the weighted representative capillary pressures to determine two of the capillary pressures; and
implying the other capillary pressure from the two capillary pressures determined using the weighted representative capillary pressures.

5. A method of claim 1, wherein the representative capillary pressures are weighted based on normalized gridblock saturations.

6. The method of claim 1, wherein the representative capillary pressures are weighted as follows:
$$\frac{{S}_{y}}{{S}_{y} + {S}_{z}} {\tilde{P}}_{cxy} ( {S}_{x}^{h} ) ,$$
where x, y and z represent phases g, o and w, in any order, where Sᵢ, i=y,z represents the gridblock saturation of phase i, where Sₓ^{h} represents the hysteresis gridblock saturation of phase x, and where \tilde{P}_{cxy}(Sₓ^{h}) is the representative x-y capillary pressure.

7. The method of claim 1, wherein the six representative capillary pressures are:
\tilde{P}_{cgo}(S_{g}^{h}), \tilde{P}_{cgo}(Sₒ^{h}), \tilde{P}_{cgw}(S_{g}^{h}), \tilde{P}_{cgw}(S_{w}^{h}), \tilde{P}_{cow}(Sₒ^{h}), \tilde{P}_{cow}(S_{w}^{h}), and the representative capillary pressures being weighted to form three expressions
$$PCG = \frac{{S}_{o}}{{S}_{o} + {S}_{w}} {\tilde{P}}_{cgo} ( {S}_{g}^{h} ) + \frac{{S}_{w}}{{S}_{o} + {S}_{w}} {\tilde{P}}_{cgw} ( {S}_{g}^{h} ) , \\ PCO = \frac{{S}_{g}}{{S}_{g} + {S}_{w}} {\tilde{P}}_{cog} ( {S}_{o}^{h} ) + \frac{{S}_{w}}{{S}_{g} + {S}_{w}} {\tilde{P}}_{cow} ( {S}_{o}^{h} ) and$$
$$PCW = \frac{{S}_{g}}{{S}_{g} + {S}_{o}} {\tilde{P}}_{cwg} ( {S}_{w}^{h} ) + \frac{{S}_{o}}{{S}_{g} + {S}_{o}} {\tilde{P}}_{cwo} ( {S}_{w}^{h} ) ,$$
solutions to the three expressions allowing for a determination of the at least two capillary pressures, where Sᵢ represents the gridblock saturation of phase i, where Sᵢ^{h} represents the hysteresis gridblock saturation of phase i, and where \tilde{P}_{cij}(Sᵢ^{h}) is the representative i-j capillary pressure.

8. The method of claim 1, further comprising:
determining the g-o capillary pressure p_{g}-pₒ based on the expression:
$$\frac{{S}_{g} {\tilde{P}}_{cog} ( {S}_{o}^{h} ) - {S}_{o} {\tilde{P}}_{cgo} ( {S}_{g}^{h} ) + {S}_{w} ( {\tilde{P}}_{cow} ( {S}_{o}^{h} ) - {\tilde{P}}_{cgw} ( {S}_{g}^{h} ) )}{{S}_{g} - {S}_{o} - {S}_{w}} ,$$
where Sᵢ represents the gridblock saturation of phase i, where Sᵢ^{h} represents the hysteresis gridblock saturation of phase i, and where \tilde{P}_{cij}(Sᵢ^{h}) is the representative i-j capillary pressure.

9. The method of claim 1, further comprising:
determining the o-w capillary pressure p₀-p_{w} based on the expression:
$$\begin{matrix}{p}_{o} - {p}_{w} = \frac{( {S}_{g} + {S}_{w} ) PCO - ( {S}_{g} + {S}_{w} ) ( {S}_{g} + {S}_{w} ) PCW}{( {S}_{w} - {S}_{o} - {S}_{g} )} \\ = \frac{{S}_{g} ( {\tilde{P}}_{cgo} ( {S}_{o}^{h} ) - {\tilde{P}}_{cgw} ( {S}_{w}^{h} ) ) - {S}_{w} {\tilde{P}}_{cow} ( {S}_{o}^{h} ) - {S}_{o} {\tilde{P}}_{cow} ( {S}_{w}^{h} )}{( {S}_{w} - {S}_{o} - {S}_{g} )} ,\end{matrix}$$
where Sᵢ represents the gridblock saturation of phase i, where Sᵢ^{h} represents the hysteresis gridblock saturation of phase i, and where \tilde{P}_{cij}(Sᵢ^{h}) is the representative i-j capillary pressure.

10. The method of claim 1, wherein the at least two determined capillary pressures are used in solving a pressure equation in a reservoir simulator, the solving of the pressure equation allowing for a determination of a physical property of the reservoir, such as a saturation profile for each of the three phases.

11. A method of simulating a saturation profile for each phase of a fluid reservoir comprising three phases g, o and w, the reservoir being considered as comprising a plurality of gridblocks, the method comprising:
receiving input data representing characteristics of the fluid reservoir;
for each gridblock of the reservoir
transforming the input data into six representative two-phase capillary pressures, the representative capillary pressures being weighted based on saturation;
transforming the weighted representative capillary pressures into at least two of the three capillary pressures g-o, o-w and g-w; and
outputting the at least two capillary pressures as output data; and
determining the saturation profile for each phase.

12. The method of claim 1, further comprising:
controlling an apparatus associated with the reservoir in dependence upon a determination made by the method.

13. A program for controlling an apparatus to perform a method as claimed in claim 1.

14. The program of claim 13, wherein the program is carried on a carrier medium.

15. The program of claim 14, wherein the carrier medium is a storage medium.

16. The program of claim 14, wherein the carrier medium is a transmission medium.

17. An apparatus programmed by the program of claim 13.

18. A storage medium containing the program of claim 13.

19. An apparatus having means for performing the steps of claim 1.

20. A method of determining capillary pressures in a fluid reservoir comprising three phases g, o and w, the reservoir being considered as comprising a plurality of gridblocks, and the method comprising, for each gridblock of the reservoir:
determining six representative two-phase capillary pressures, the representative capillary pressures being weighted based on saturation; and
using the weighted representative capillary pressures to determine at least two of the three capillary pressures g-o, o-w and g-w.

21. A system for determining capillary pressures in a fluid reservoir comprising three phases g, o and w, the reservoir being considered as comprising a plurality of gridblocks, the system comprising:
received input data representing characteristics of the fluid reservoir; and
for each gridblock or the reservoir
transformed input data, the transformed input data being the received input data transformed into six representative two-phase capillary pressures, the representative capillary pressures being weighted based on saturation;
weighted data, the weighted data being the weighted representative capillary pressures transformed into at least two of the three capillary pressures g-o, o-w and g-w; and
output data, the output data representing the at least two capillary pressures.

22. A system for simulating a saturation profile for each phase of a fluid reservoir comprising three phases g, o and w, the reservoir being considered as comprising a plurality of gridblocks, the system comprising:
received input data representing characteristics of the fluid reservoir;
for each gridblock of the reservoir
transformed input data, the transformed input data being the received input data transformed into six representative two-phase capillary pressures, the representative capillary pressures being weighted based on saturation;
weighted data, the weighted data being the weighted representative capillary pressures transformed into at least two of the three capillary pressures g-o, o-w and g-w; and
output data, the output data representing the at least two capillary pressures; and
a saturation profile for each phase.

23. A computer-readable medium having executable code to cause a machine to perform a method of determining capillary pressures in a fluid reservoir comprising three phases g, o and w, the reservoir being considered as comprising a plurality of gridblocks, the method comprising:
receiving input data representing characteristics of the fluid reservoir; and
for each gridblock of the reservoir
transforming the input data into six representative two-phase capillary pressures, the representative capillary pressures being weighted based on saturation;
transforming the weighted representative capillary pressures into at least two of the three capillary pressures g-o, o-w and g-w; and
outputting the at least two capillary pressures as output data.

24. A computer-readable medium having executable code to cause a machine to perform a method of simulating a saturation profile for each phase of a fluid reservoir comprising three phases g, o and w, the reservoir being considered as comprising a plurality of gridblocks, the method comprising:
receiving input data representing characteristics of the fluid reservoir;
for each gridblock of the reservoir
transforming the input data into six representative two-phase capillary pressures, the representative capillary pressures being weighted based on saturation;
transforming the weighted representative capillary pressures into at least two of the three capillary pressures g-o, o-w and g-w; and
outputting the at least two capillary pressures as output data; and
determining the saturation profile for each phase.
